(19) United States
(12) Patent Application Publication
(10) Pub. No.: US 2010/0257411 A1
(43) Pub. Date: Oct. 7, 2010

(54) EMULATION DEVICE AND EMULATOR ACTIVATION METHOD

(75) Inventors: Kouichi Mase, Chiba-ken (JP); Yoshiko Suenaga, Kanagawa-ken (JP); Kazuto Oonuma, Tokyo (JP); Katsuaki Nagata, Tokyo (JP); Hironori Tanaka, Shizuoka-ken (JP); Masamitsu Tsuchiya, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/754,789

(22) Filed: Apr. 6, 2010

Related U.S. Application Data
(60) Provisional application No. 61/167,214, filed on Apr. 7, 2009.

(30) Foreign Application Priority Data
Jan. 25, 2010 (JP) 2010-013273

(51) Int. Cl. G06F 11/07; G06F 9/455; G06F 3/048

(52) U.S. Cl. 714/49; 703/23; 715/810; 714/E11.025

(57) ABSTRACT

According to one embodiment, an emulation device includes a storing section that stores model information of an apparatus that can be emulated and an emulator corresponding to the model information, an obtaining section that obtains the model information of the apparatus, a detection section that detects, from the model information in the storing section, model information corresponding to the model information of the apparatus obtained by the obtaining section, and an executing section that activates an emulator of the apparatus corresponding to the detected model information.

### CROSS-REFERENCE TO RELATED APPLICATION

This application is based upon and claims the benefit of priority from the prior U.S. Patent Application No. 61/167,214, filed on Apr. 7, 2009, the entire contents of which are incorporated herein by reference.

This application is also based upon and claims the benefit of priority from Japanese Patent Application No. 2010-13273, filed on Jan. 25, 2010, the entire contents of which are incorporated herein by reference.

### TECHNICAL FIELD

Exemplary embodiments described herein relate to an emulation device for emulating an image forming apparatus and an emulator activation method.

### BACKGROUND

Recently, a design support system for an image forming apparatus using simulation/emulation techniques has been suggested. This system virtually reproduces a portion or all of an image forming apparatus, and contributes to efficient analysis for designing software specifications or at occurrence of failure. For example, a system described in US 2007/0202473 A1 virtually reproduces image forming process on the assumption of user's actual use of an image forming apparatus, in an environment in which an image forming apparatus does not actually exist. When virtual image forming process is executed, the user sets image forming instructions as well as the type of the image forming apparatus so as to select a target image forming apparatus to be reproduced from among a plurality of image forming apparatuses.

However, in the above system, the target image forming apparatus to be virtually reproduced is simply selected by manual operation. Therefore, when there are many types of image forming apparatuses, it may be cumbersome for the user to select a target, the user may make a mistake in selecting a target, and further the user may proceed with the development without noticing the mistake made in the selection of the target. Conventionally, there are a plurality of models of image forming apparatuses according to printing speed, software function, or performance. Even the same model may have a different version of software as a result of updating process. Therefore, the more the selection targets, the more likely the above problems may occur.

### SUMMARY

An aspect of the present disclosure relates to an emulation device containing a storing section that stores model information of an apparatus that can be emulated and an emulator corresponding to the model information, an obtaining section that obtains the model information of the apparatus, a detection section that detects, from the model information in the storing section, model information corresponding to the model information of the apparatus obtained by the obtaining section, and an executing section that activates an emulator of the apparatus corresponding to the detected model information.

Another aspect of the present disclosure relates to an activation method of an emulator on an emulation apparatus having a storing section that stores model information of an apparatus that can be emulated and an emulator corresponding to the model information, the activating method including obtaining model information of an apparatus, detecting, from the model information in the storing section, model information corresponding to the obtained model information of the apparatus, and activating an emulator of the apparatus corresponding to the detected model information.

### BRIEF DESCRIPTION OF THE DRAWINGS

FIG. 1 is an external view of an image forming apparatus;

FIG. 2 is a block diagram for illustrating a software configuration of the image forming apparatus;

FIG. 3 is schematic block diagram showing a control system of the image forming apparatus;

FIG. 4 is a block diagram for illustrating a configuration of an emulation device according to an aspect;

FIG. 5 is a front view showing an example of an operation screen of the emulator shown in FIG. 4;

FIG. 6 is a front view showing an example of another operation screen of the emulator shown in FIG. 4;

FIG. 7 is a schematic diagram showing an example of a version information displaying screen;

FIG. 8 is a network configuration diagram showing an emulation system relating to a network connected with the emulation device shown in FIG. 4;

FIG. 9 is a schematic block diagram showing a control system of the emulation device of FIG. 8;

FIG. 10 is a block diagram for illustrating a functional configuration of the emulation device of FIG. 8;

FIG. 11 is a flowchart for illustrating a flow of setting target model information when the emulator shown in FIG. 4 is activated;

FIG. 12, as well as FIG. 11, is a flowchart for illustrating a flow of setting target model information when the emulator shown in FIG. 4 is activated;

FIG. 13 is a schematic diagram showing an example of an affirmation screen;

FIG. 14 is a schematic diagram showing an example of a setting screen;

FIG. 15 is a schematic diagram showing an example of a selection screen; and

FIG. 16 is a schematic diagram showing another example of the setting screen.

### DETAILED DESCRIPTION

An embodiment will be hereinafter described with reference to the drawings.

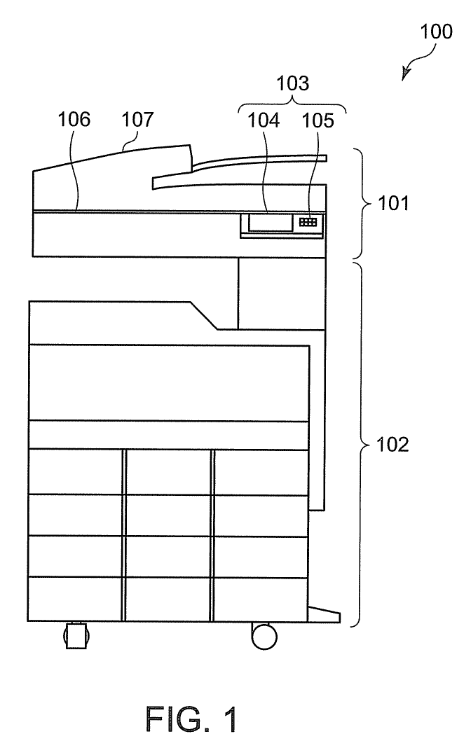

FIG. 1 is an external view showing an example of an image forming apparatus. An image forming apparatus 100 includes a scanner unit 101 for reading an original document, a printer unit 102 for forming an image, and an operation panel 103.

The operation panel 103 includes a touch-panel display 104 and various operation keys 105. The operation keys 105 include, for example, a ten key, a reset key, a stop key, and a start key. The display 104 displays various instruction items such as sheet sizes, the number of copies, a setting of printing density, and post-processing (binding, folding). The instructions are input on the display 104.

The scanner unit 101 includes an embedded scan reading unit (not shown) for reading an original document as an image, a document table 106, and an automatic document feeder 107 for conveying an original document to a reading position. The scan reading unit of the scanner unit 101 reads an original document set on the document table 106 or the automatic document feeder 107.

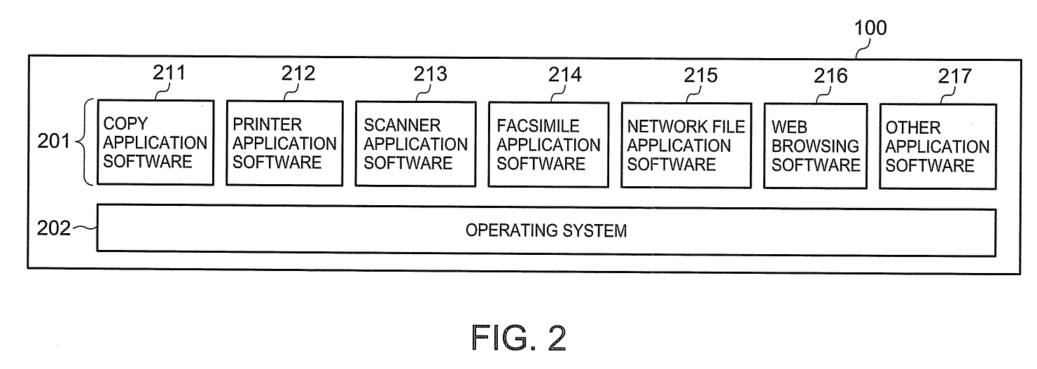

FIG. 2 is a block diagram for illustrating an example of a software configuration of the image forming apparatus 100. The image forming apparatus 100 includes an application software portion 201 and an Operation System (OS) 202 for operating application software of the application software portion 201.

The application software portion 201 includes application software for executing functions of the image forming apparatus such as copy function application software (copy application software) 211, print function application software (printer application software) 212, scanner function application software (scanner application software) 213, facsimile function application software (facsimile application software) 214, and network file function application software (network file application software) 215. Further, the application software portion 201 includes web client application software (web browsing software) 216 and other application software 217.

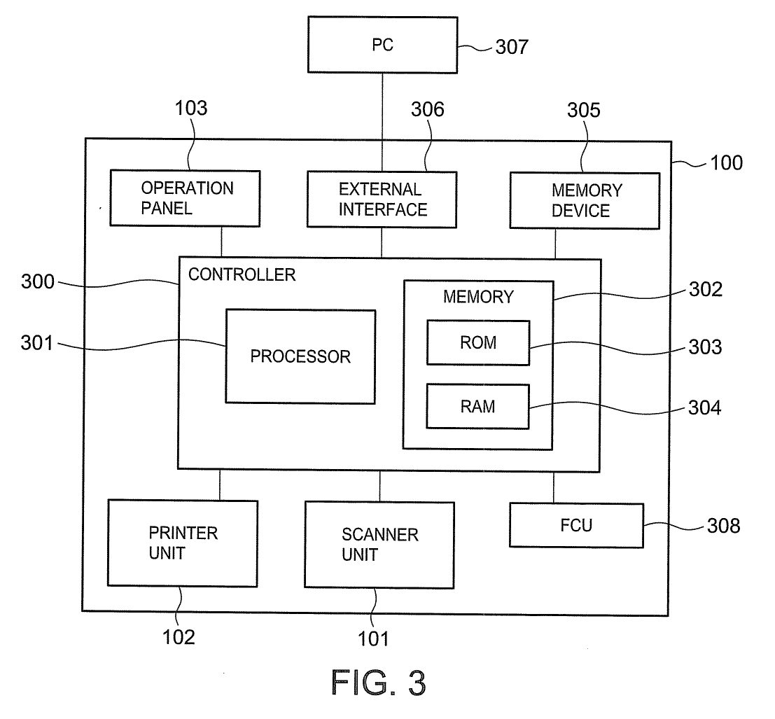

FIG. 3 is schematic block diagram showing an example of a control system of the image forming apparatus 100. The image forming apparatus 100 includes a controller 300. The controller 300 functions by a processor 301 constituted by a CPU (Central Processing Unit) or an MPU (Micro Processing Unit), a memory 302, and the OS 202 shown in FIG. 2. The memory 302 is, for example, a semiconductor memory, and includes a ROM (Read Only Memory) 303 storing a control program of the processor 301, namely, the OS, and a RAM (Random Access Memory) 304 providing a temporary work area to the processor 301. The controller 300 controls the scanner unit 101, the printer unit 102, the operation panel 103, and a facsimile controlling section (FCU) 308. The controller 300 further includes functions for correcting or stretching image data.

The controller 300 is connected to a memory device 305 and an external interface (I/F) 306. The memory device 305 temporarily stores, for example, compressed image data or print data. The memory device 305 may be, for example, a magnetic memory device such as a hard disk drive, an optical memory device, a semiconductor memory device (such as a flash memory), or any combination of these memory devices. The memory device 305 appropriately saves software updates, protected electronic documents, text data, account information, policy information, and the like.

The external interface 306 is an interface for connecting to external apparatuses. The external interface 306 is appropriate wireless or wired network communication means such as IEEE802.15, IEEE802.11, IEEE802.3, IEEE1284 such as Bluetooth (registered trademark), infrared light connection, and optical connection. The external interface 306 may further include a USB connection unit connected with a connection terminal conforming to USB standard. The controller 300 communicates with a personal computer (PC) 307, a USB device, and other external apparatuses via the external interface 306.

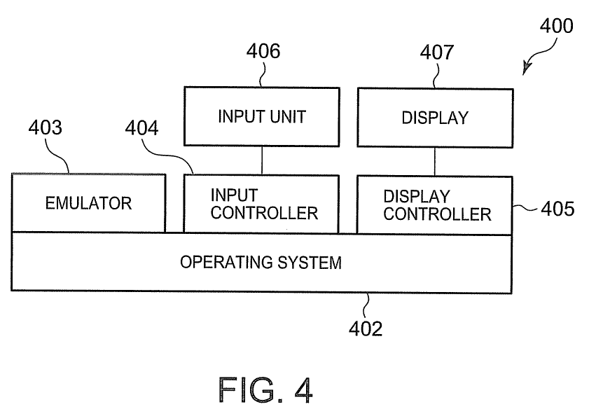

Subsequently, an emulation device will be described that virtually executes a portion or all of the functions/operations of the image forming apparatus. A personal computer (PC) may be used as the emulation device. FIG. 4 is a block diagram for illustrating a configuration of the emulation device. An emulation device 400 such as a personal computer includes an Operating System (OS) 402, an emulator 403, an input controller 404, and a display controller 405.

The emulator 403 operates as an application of the Operating System 402 running on the emulation device 400. For example, the emulator 403 functions after the emulator 403 has been installed to a memory device such as a hard disk drive of the emulation device 400. The emulator 403 virtually executes a portion or all of the functions/operations of the image forming apparatus 100 illustrated in FIGS. 1 to 3. Therefore, the emulator 403 according to the present embodiment does not necessarily require an actual apparatus. The emulator 403 emulates a single model of image forming apparatus or a plurality of models of image forming apparatuses.

The input controlling section controls an input unit 406. The input unit 406 uses a keyboard device and a mouse as a man-machine interface. The input controller 404 receives input from the input unit 406.

The display controller 405 controls a display 407. In the present aspect, the display 407 is, for example, a display attached to the PC. The display controller 405 displays, on the display 407, a functional screen about the activated emulator 403.

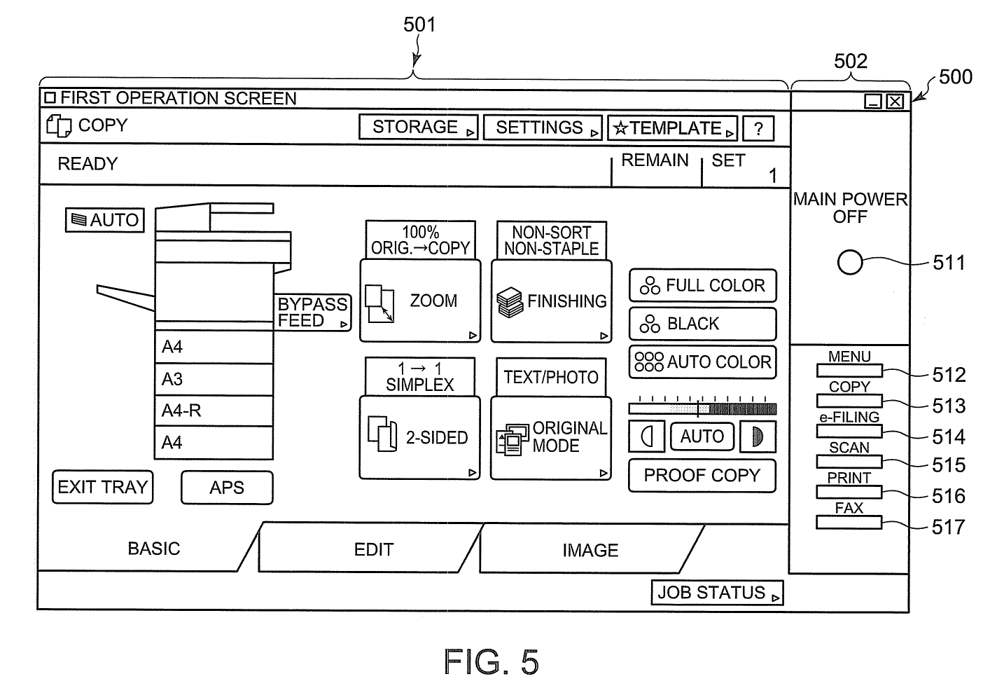

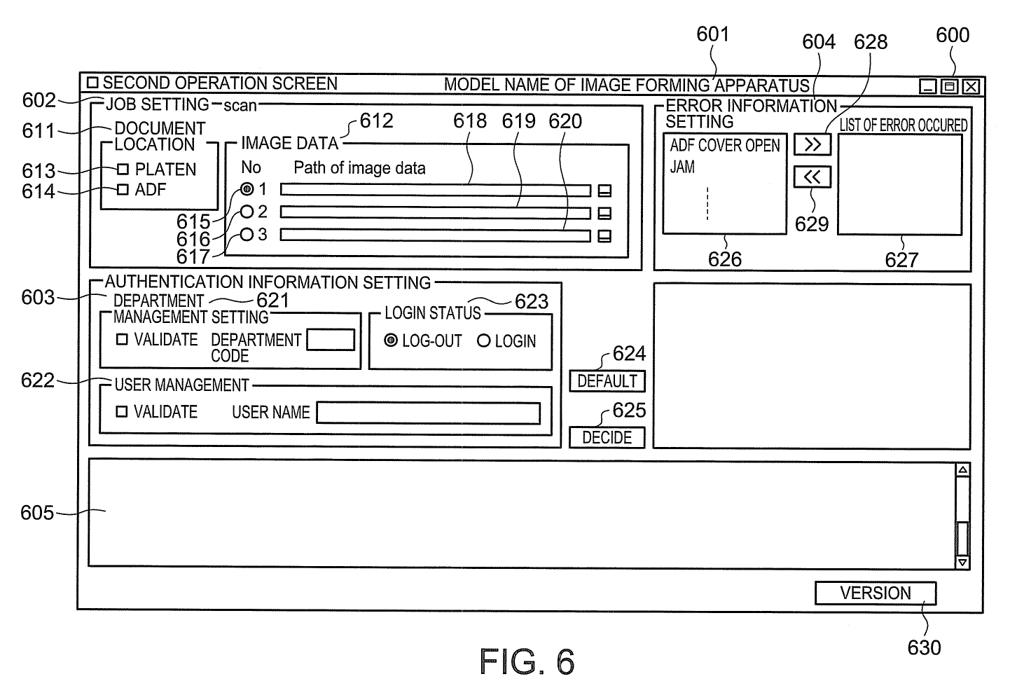

FIGS. 5 and 6 show examples of operation screens of the emulator 403 displayed on the display 407 shown in FIG. 4. When the emulator 403 for a predetermined model is activated, the display 407 displays a first operation screen 500 shown in FIG. 5 and a second operation screen 600 shown in FIG. 6.

The first operation screen 500 schematically displays the operation panel of the actual image forming apparatus. For example, the first operation screen 500 is displayed on the display 407 as a GUI (Graphical User Interface) that realizes the same operability, the same screen transitions, and the same screen display timing as those of the operation panel 103 of the image forming apparatus 100. Each operation made on the first operation screen 500 is input by the input unit 406. The emulation device 400 uses the first operation screen 500 displayed on the display 407 and the input unit 406 to virtually execute the display and the operation that would be performed on the operation panel 103 of the image forming apparatus 100. The second operation screen 600 is a screen for setting the state of the selected image forming apparatus 100. The display controller 405 may cause the display 407 to display the first operation screen 500 and the second operation screen 600 as one GUI or separately as different GUIs. When the first and second operation screens are displayed as different GUIs, the display controller 405 may display any one of the screens first. In the present embodiment, the display controller 405 displays the first operation screen 500 and the second operation screen 600 as different GUIs at the same time in such a manner that any one of the screens is rendered active.

The first operation screen 500 will be further described in detail. As shown in FIG. 5, the first operation screen 500 includes a panel displaying area 501 and a hard keys area 502. The panel displaying area 501 displays a screen image of the display 104 of the image forming apparatus 100.

The hard keys area 502 displays a button representing the operation key 105, i.e., a hard key of the image forming apparatus 100. The display in the hard keys area 502 may be common to all the models. The hard keys area 502 is arranged with a MAIN POWER OFF button 511, a MENU button 512, a COPY button 513, an e-FILING button 514, a SCAN button 515, a PRINT button 516, and a FAX button 517. The MAIN POWER OFF button 511 corresponds to a POWER ON/OFF button of the image forming apparatus 100. It should be noted that only POWER OFF function is executed because the emulator has already been activated in the present embodiment. When the MAIN POWER OFF button 511 is manipulated via the input unit 406, the emulator is terminated after the termination is confirmed. The MENU button 512 is a button for transiting to a MENU screen. The COPY button 513 is a button for transiting to a COPY screen. The e-FILING button 514 is a button for transiting to an e-FILING screen. The SCAN button 515 is a button for transiting to a SCAN screen. The PRINT button 516 is a button for transiting a PRINT screen. The FAX button 517 is a button for transiting to a FAX screen. The panel displaying area 501 of FIG. 5 displays, for example, the COPY screen showing a result of operation of the COPY button 513. After the screen transits to anther screen in response to manipulation of the other buttons, the screen would be the same as that displayed by the well-known image forming apparatus, and accordingly the description thereof will be omitted.

Subsequently, the second operation screen 600 will be described in detail. As shown in FIG. 6, the second operation screen 600 includes, for example, a title area 601, a job setting area 602, an authentication information setting area 603, an error information setting area 604, and a communication situation displaying area 605.

The title area 601 displays the type of the model of the image forming apparatus during emulation.

In the job setting area 602, a job to be emulated is set. For example, in the present embodiment, a scan job such as DPWS (Device Profile for Web Service) scan is set. The job setting area 602 includes a document location setting section 611 and an image data setting section 612.

In the document location setting section 611, positional information about the original document for the scan job is set. The document location setting section 611 includes a check box 613 for setting the original document position to the platen and a check box 614 for setting the original document position to an ADF (Automatic Document Feeder). When the check box is checked, a setting is made such that an original document to be scanned is placed in the corresponding position. When the check box is unchecked, a setting is made such that the original document to be scanned is removed therefrom. According to the set condition, the scan operation is emulated.

In the image data setting section 612, a path to a folder storing corresponding image data as a scan result is set. A plurality of paths of image data may be set in advance. In the present embodiment, image data paths No. 1 to No. 3 can be set. Regarding the scan result, among the image data No. 1 to No. 3, image data located in the path selected by radio buttons 615, 616, and 617 or image data stored in the folder having the path is given as a scanned image.

In text boxes 618 to 620, folders storing the image data given as the scan result or paths of the image data are set. For example, when a folder path is specified, image data stored in the folder are targeted for being given as the scan result. It should be noted that when a plurality of pages are given as the scan result in a single page format, an image data file corresponding to the number of pages is prepared in advance in the folder.

In the authentication information setting area 603, information or state of authentication of a department or a user is set. In a department management setting section 621, department management is set to either effective or non-effective state and a department code used for login is set. In a user management setting section 622, user management is set to either effective or non-effective state and a user name used for login is set. In a login status setting section 623, one of logout and login is selected so as to set a login state to the image forming apparatus. More specifically, when the logout is selected, the emulator 403 attains a state in which neither department authentication nor user authentication is performed on the operation panel 103 of the image forming apparatus 100. When the login is selected, the emulator 403 attains a state in which the department authentication or the user authentication has been performed on the operation panel 103 of the image forming apparatus 100.

When a default icon 624 is selected, the setting values in the job setting area 602 and the authentication information setting area 603 are changed back to default values. When a fixedness icon 625 is selected, the setting values in the job setting area 602 and the authentication information setting area 603 are decided.

The error information setting area 604 is a GUI for emulating operation during occurrence of an error in the image forming apparatus 100. In the error information setting area 604, whether an error occurs or is canceled is set. The error information setting area 604 includes a first displaying area 626, a second displaying area 627, an error setting icon 628, and an error cancellation icon 629.

The first displaying area 626 displays an error list showing errors that may occur. When the error setting icon 628 is selected while an error displayed on the first displaying area 626 is selected, the selected error is display in the second displaying area 627, and an error occurs in the emulation. A selection of a plurality of errors may be allowed.

The second displaying area 627 displays a list of selected errors or errors currently occurring in the emulation. When the error displayed cancellation icon 629 is selected while an error on the second displaying area 627 is selected, the selected error is deleted from the second displaying area 627, and the error is canceled.

When the error setting icon 628 is selected, the selected error is decided. In the present embodiment, when the error setting icon 628 is selected with the input unit 406, the error cancellation icon 629 cancels the selected error.

The communication situation displaying area 605 displays, in real time, communication situation messages of the emulator that are generated after the emulator is activated. For example, when the error setting icon 628 is selected while an error displayed on the first displaying area 626 is selected, the communication situation displaying area 605 displays a message indicating occurrence of an error as soon as the error occurs. When the error cancellation icon 629 is selected while the error displayed on the second displaying area 627 is selected, the communication situation displaying area 605 displays a message indicating cancellation of the error as soon as the error is cancelled. When the message does not fit within the width of the communication situation displaying area 605, a side scroll bar is enabled so that the user can read the message by scrolling the screen to the end of the message.

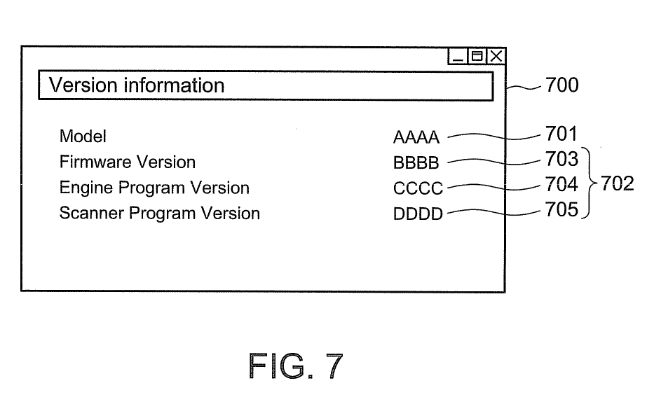

When a version information icon 630 is selected, a version information displaying screen 700 of FIG. 7 is displayed. FIG. 7 shows an example of detailed version information such as software and firmware about the model being emulated. The version information displaying screen 700 includes, for example, machine model data 701 and version information 702. The version information 702 includes information about, for example, a firmware version 703, an engine program version 704, a scanner program version 705, and the like. The firmware version 703 is version information of a control system program including an OS 202, and is stored in a memory device such as a hard disk drive and a ROM. The engine program version 704 is version information of a program for controlling hardware of the printer unit 102, and is stored in a memory such as a ROM. The scanner program version 705 is version information of a program for controlling hardware of the scanner unit 101, and is stored in a memory such as a ROM. The firmware version 703, the engine program version 704 and the scanner program version 705 are collectively called version information. It should be noted that the machine model data 701 may represent the model name of the image forming apparatus 100, or may represent identification information associated with the model.

Even though the machine model data 701 is the same, the version information 702 may be different in other version information such as the firmware version 703 as a result of the process of updating. When the emulator 403 is activated in order to develop an application, it is necessary to appropriately set a model for which the application is developed, and to appropriately set versions such as the firmware version. However, it is cumbersome to select and set an item from among many options, and in such case, the user is more likely to make a mistake in selecting the item.

The emulated model and the target model information including various kinds of version information are set when the emulator 403 is activated. The setting of the target model information about the mode activated by the emulator 403 will be hereinafter explained.

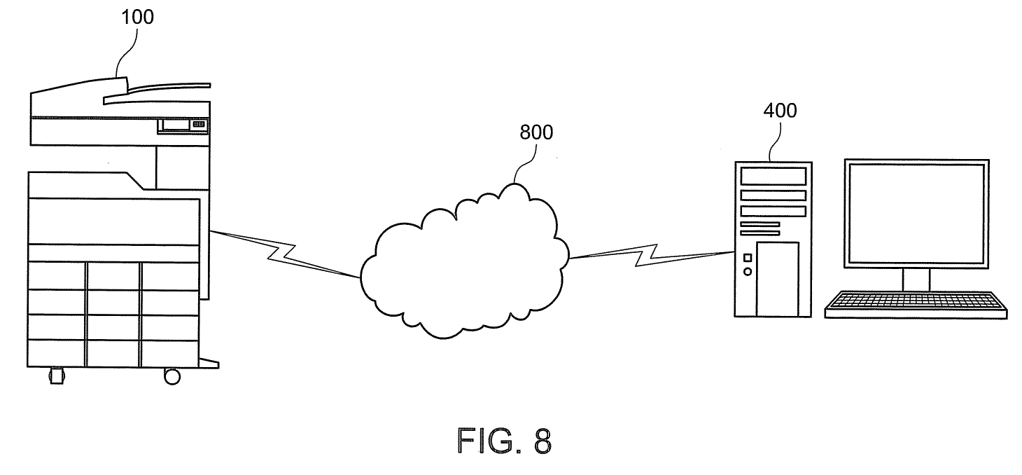

FIG. 8 is a network configuration diagram showing an emulation system relating to a network connected with the emulation device 400 according to the present embodiment. A connection with an actual apparatus is not necessarily required when the emulator 403 on the emulation device 400 is executed. In the present embodiment, however, it is assumed that at least one image forming apparatus is connected to the emulation device 400 via a network. As shown in the figure, the image forming apparatus 100 and the emulation device 400 are connected via a network 800. The emulation device 400 includes software, hardware, or an appropriate combination thereof for performing communication and the like with the image forming apparatus 100. Further, the emulation device 400 includes an appropriate interface such as a web browsing software or other dedicated applications for exchanging various web pages, device pages, and the like. The network 800 may use appropriate wireless or wired network communication such as IEEE802.15, IEEE802.11, IEEE802.3, and IEEE1284.

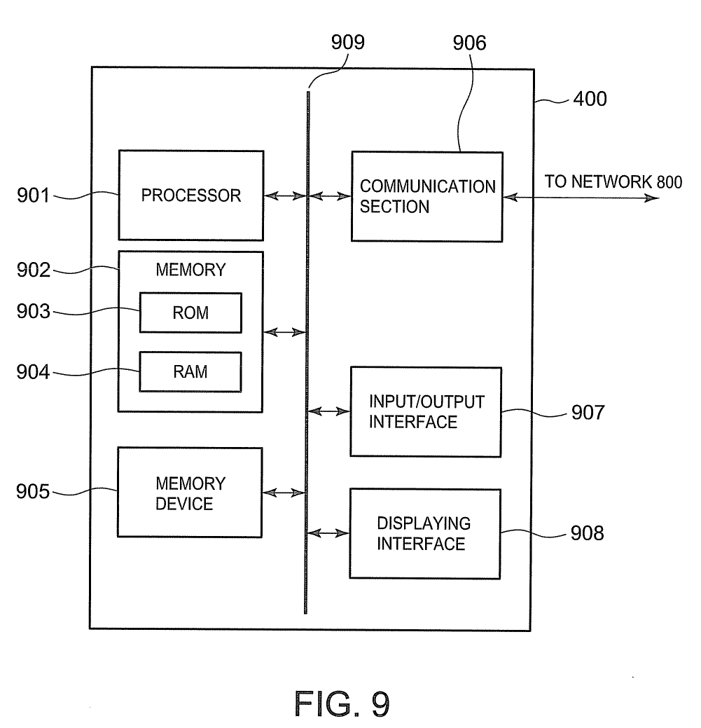

FIG. 9 a schematic block diagram showing a control system of the emulation device 400. The emulation device 400 includes a processor 901, a memory 902, a memory device 905, a communication section 906, an input/output interface 907, and a displaying interface 908. The memory 902 includes a ROM 903 storing a control program for the processor 901 and a RAM 904 providing a work area to the processor 901. Components of the emulation device 400 are connected via a bus 909.

The emulator 403 is installed in the memory device 905. After the emulator 403 is installed, the memory device 905 stores model information of the image forming apparatus that can be emulated by the emulator 403. The memory device 905 may be, for example, a magnetic memory device such as a hard disk drive, an optical memory device, a semiconductor memory device such as a flash memory, or any combination of these memory devices.

The communication section 906 is an interface for connecting to external apparatuses. In the present embodiment, the communication section 906 communicates with the image forming apparatus 100 via the external interface 306 of the image forming apparatus 100 and the network 800.

The input/output interface 907 is connected to the input unit 406.

The displaying interface 908 receives an instruction or data to be displayed on the display 407 from other components connected with the bus 909. The displaying interface 908 outputs the display data to the display 407.

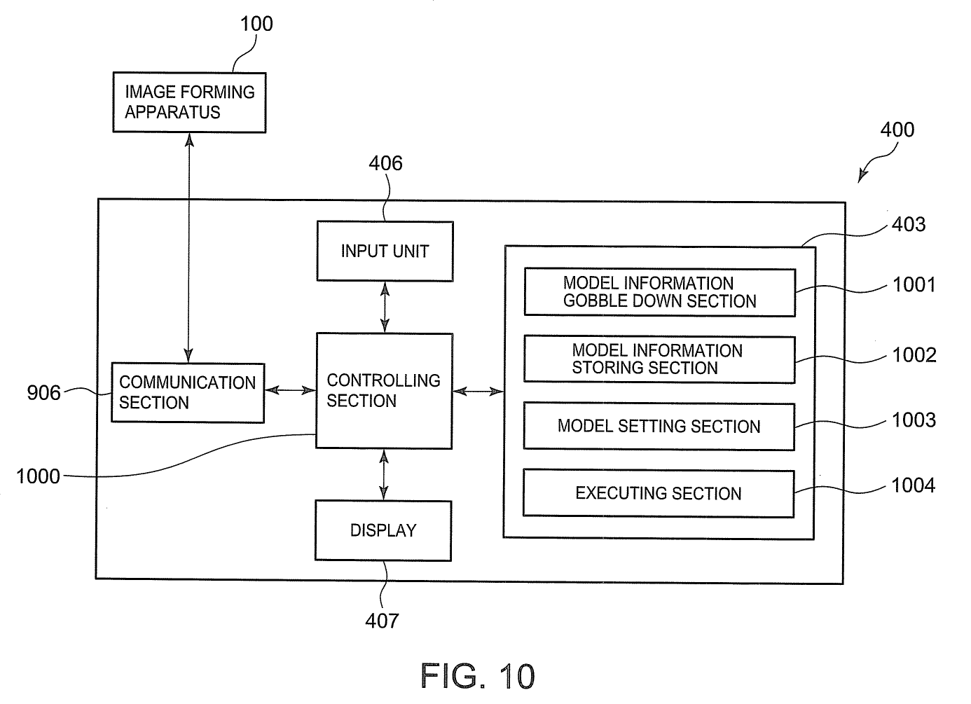

FIG. 10 is a block diagram for illustrating a functional configuration of the emulation device 400. The emulation device 400 includes a controller 1000, a model information gobble down section 1001, a model information storing section 1002, a model setting section 1003, and an executing section 1004. In the present embodiment, for example, the model information gobble down section 1001, the model information storing section 1002, the model setting section 1003, and the executing section 1004 are explained as functions executed by the emulator 403.

The controller 1000 is constituted by the processor 901 and the memory 902 shown in FIG. 9, and the OS 402 shown in FIG. 4. The controller 1000 also functions as the input controller 404 and the display controller 405.

The model information gobble down section 1001 obtains the model information of the image forming apparatus 100 connected to the emulation device 400 via the network 800. The model information gobble down section 1001 detects the image forming apparatus 100 by broadcasting a packet to the network 800 via the communication section 906, and obtains the model information from the detected image forming apparatus 100. The model information (first model information) obtained by the model information gobble down section 1001 includes, for example, the version information and the machine model data shown in FIG. 7.

The model information storing section 1002 previously stores the model information (second model information) of the image forming apparatus that can be emulated by the emulator 403, an emulation program of the image forming apparatus, and association information for associating this model information with the emulation program. The model information (second model information) includes, for example, the machine model data and the version information. The version information includes, for example, the firmware version, the engine program version, and the scanner program version. The model information stored in the model information storing section 1002 corresponds to the model information obtained by the model information gobble down section 1001. The model information storing section 1002 stores, in association with the model information, the program of the image forming apparatus activated by the emulator. The model setting section 1003 sets the model information of the image forming apparatus activated by the emulator 403, based on the model information obtained by the model information gobble down section 1001 and the model information stored in the model information storing section 1002. The executing section 1004 activates the program of the image forming apparatus corresponding to the model information having been set. When the emulator 403 starts to emulate the image forming apparatus, the controller 1000 causes the display 407 to display the first operation screen 500 and the second operation screen 600. The controller 1000 may function as the model setting section 1003.

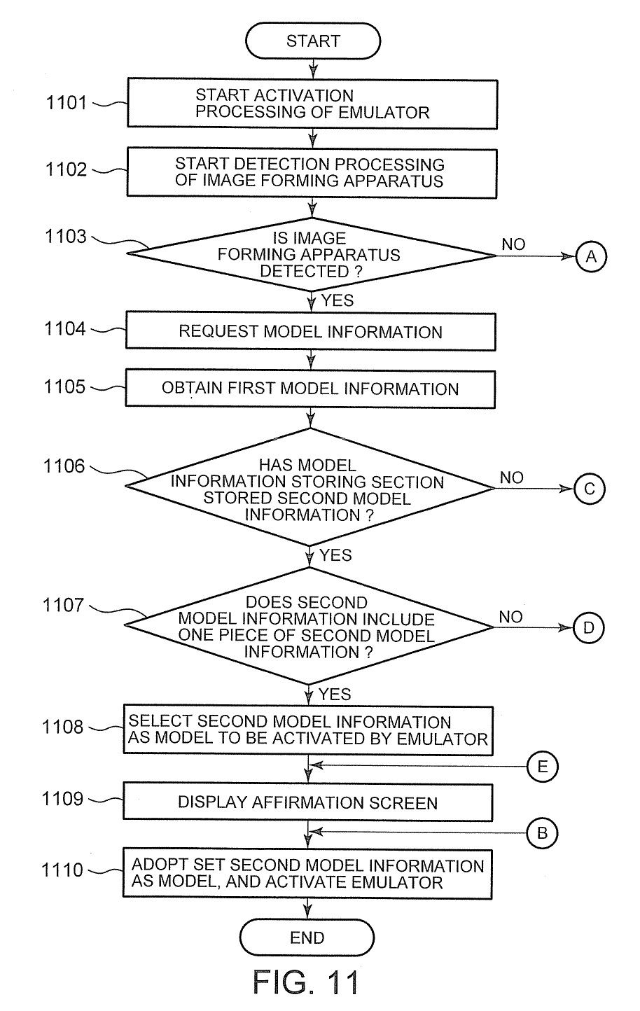

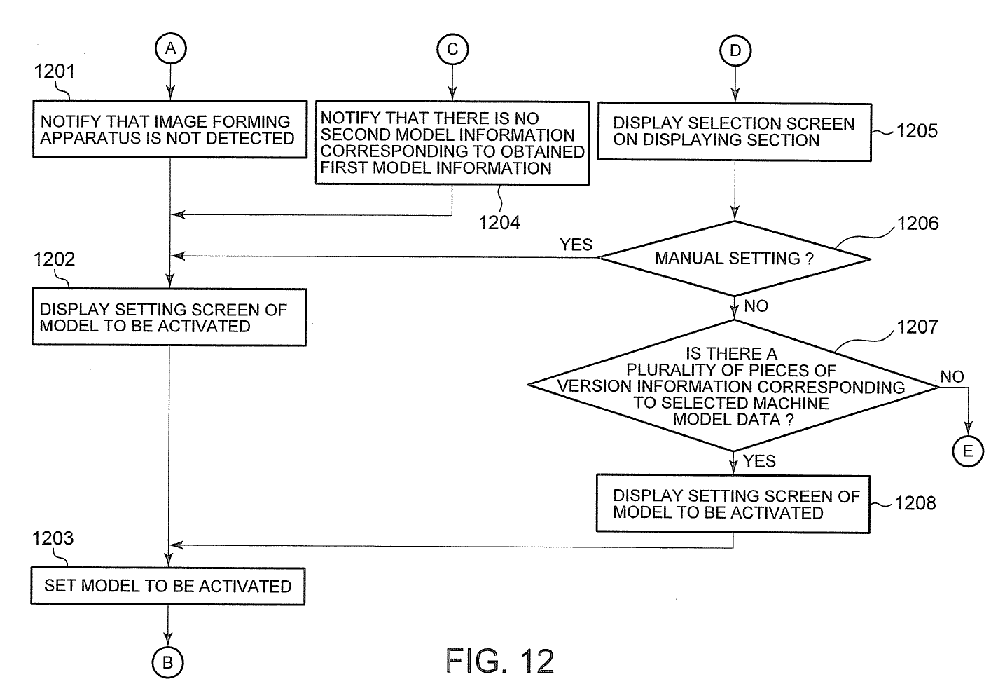

Subsequently, the processing operation of the activation of the emulator 403 in the emulation device 400 will be explained using FIG. 11. FIGS. 11 and 12 are flowcharts illustrating flows of setting target model information when the emulator 403 is activated.

When the user manipulates the input unit 406 to activate the emulator 403, the controller 1000 starts activation processing of the emulator 403 in step 1101. For example, the user activates the emulator 403 by using the input unit 406 to click an activation icon of the emulator or a shortcut icon or input a command.

When the emulator 403 starts the activation processing, the model information gobble down section 1001 starts, in 1102, detection processing of an image forming apparatus on the network 800, for example, the image forming apparatus 100, which is connected to the emulation device 400. The model information gobble down section 1001 detects the image forming apparatus 100 by broadcasting a packet via the communication section 906.

When the image forming apparatus 100 connected to the network 800 is detected (Yes in 1103), the model information gobble down section 1001 requests the model information from the detected image forming apparatus 100 via the communication section 906 in 1104. In 1105, the model information gobble down section 1001 obtains the model information (first model information) of the detected image forming apparatus 100 via the communication section 906.

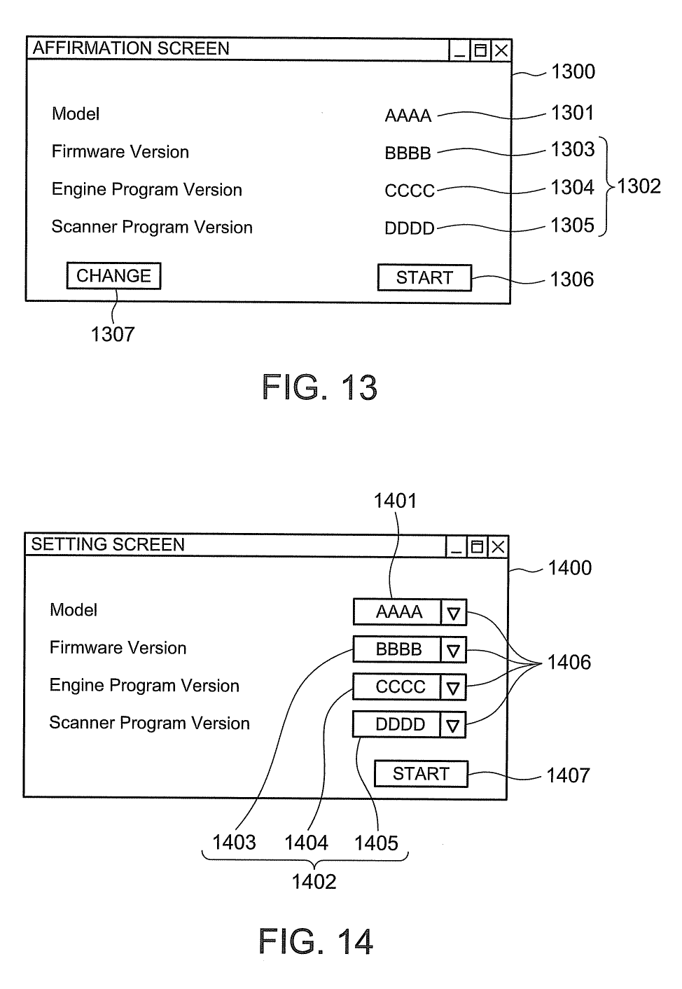

When the first model information is obtained, the model setting section 1003 determines, in 1106, whether the model information storing section 1002 has stored therein the model information (second model information) of the image forming apparatus that can be activated by the emulator 403 and that corresponds to the obtained first model information. In other words, the model setting section 1003 serves as a detection unit, and detects the second model information corresponding to the first model information from the model information storing section 1002. When the model information storing section 1002 includes the second model information (Yes in 1106), the model setting section 1003 serves as a determination unit, and determines whether the detected second model information includes a single or a plurality of pieces of second model information in 1107. When the second model information includes a single piece of second model information (Yes in 1107), the model setting section 1003 selects, in 1108, the detected second model information as the model information of the image forming apparatus to be activated by the emulator 403. In 1109, the model setting section 1003 displays an affirmation screen 1300 as shown in FIG. 13. For example, numeral 1301 denotes machine model data, and numeral 1302 denotes version information. The version information 1302 includes a firmware version 1303, an engine program version 1304, and a scanner program version 1305. In the present embodiment, the affirmation screen 1300 is displayed in such a manner that the second model information selected in 1108 is set. When a starting button 1306 is selected on the affirmation screen 1300, the executing section 1004 starts, in 1110, the program of the image forming apparatus corresponding to the second model information having been set, namely, the executing section 1004 starts the emulator 403. When the emulator 403 starts to emulate the image forming apparatus corresponding to the second model information, the emulator 403 causes the display 407 to display the first operation screen 500 and the second operation screen 600 as described above.

The affirmation screen 1300 may allow change of the model information such as the machine model data 1301 and the version information 1302. For example, when a changing button 1307 is selected, appropriate information can be input, through typing or selection, to the items of the machine model data 1301 and the version information 1302.

In the flowchart of FIG. 11, 1109 for displaying the affirmation screen may be omitted. For example, in 1108, the model setting section 1003 sets the second model information, and thereafter, the program proceeds to 1110, at which the executing section 1004 automatically starts the emulator 403.

On the other hand, when the image forming apparatus 100 connected to the network 800 is not detected (No in 1103), the program proceeds to 1201 of FIG. 12, and the display 407 notifies the user that the image forming apparatus 100 is not detected.

Subsequently, in 1202, the model setting section 1003 prompts the user to set the target model information to be activated. For example, the model setting section 1003 causes the display 407 to display a setting screen 1400 shown in FIG. 14. Numeral 1401 denotes machine model data, and numeral 1402 denotes version information. The version information 1402 includes a firmware version 1403, an engine, program version 1404, and a scanner program version 1405. Numeral 1406 denotes a setting section for selecting a predetermined item of the model information, and may be, for example, a pull-down menu. The model information is selected from the second model information stored in the model information storing section 1002.

When the target model information to be activated is input and thereafter a starting button 1407 of the setting screen 1400 is selected, the model setting section 1003 decides the target model information to be activated in 1203. The executing section 1004 starts the program of the image forming apparatus corresponding to the second model information having been set, namely, starts the emulator 403.

In a case where the image forming apparatus 100 connected to the network 800 is detected and the first model information is obtained but the second model information corresponding to this first model information does not exist (No in 1106), the display 407 notifies the user, in step 1204, that the second model information corresponding to the obtained first model information does not exist. In this case, the user may set, as the target model information to be activated, another piece of model information different from the first model information. Namely, the program proceeds to 1202, and thereafter, executes the same processing as that performed when the image forming apparatus 100 is not detected in 1103.

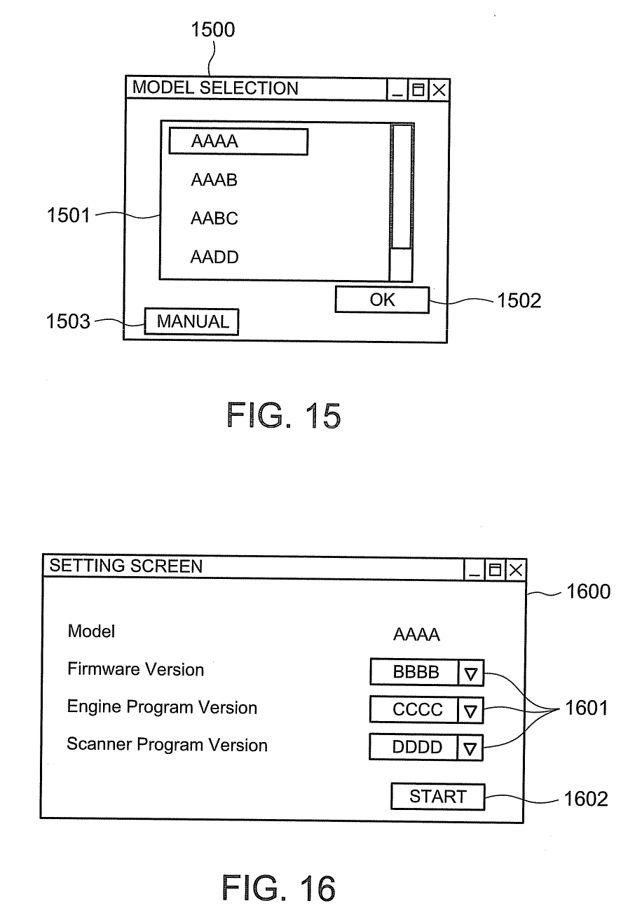

When the detected second model information includes a plurality of pieces of second model information (No in 1107), the model setting section 1003 causes the display 407 to display a selection screen 1500 shown in FIG. 15 in 1205.

In a selection area 1501 of the selection screen 1500, the machine model data about a plurality of pieces of detected second model information is displayed. For example, FIG. 15 shows a state in which machine model data AAAA is selected. The machine model data of the target model to be activated is selected, and thereafter an OK button 1502 is selected. As a result of the above operation, the target model to be activated is set.

When a manual setting button 1503 is selected (Yes in 1206), the program proceeds to the processing in 1202, in which the setting screen 1400 shown in FIG. 14 is displayed. Therefore, the user can select a model other than the models displayed in the selection area 1501.

When the machine model data of the second model information is selected from the selection area 1501 (No in 1206), the model setting section 1003 serves as a determination unit, and determines, in 1207, whether there are a plurality of pieces of version information corresponding to the selected machine model data. Even though the machine model data is the same, the firmware version and the engine program version may be different through the updating process, namely, the version information may be different. Accordingly, the model setting section 1003 determines whether there is any different version information based on the combination of the firmware version, the engine program version, and the scanner program version. When there is only one piece of version information corresponding to the selected machine model data (No in 1207), the program proceeds to 1109, in which the affirmation screen 1300 shown in FIG. 13 is displayed.

When there are a plurality of pieces of version information corresponding to the selected machine model data (Yes in 1207), the model setting section 1003 causes the display 407 to display a setting screen 1600 shown in FIG. 16 in 1208. In the present embodiment, the machine model data is decided, and a setting section (for example, a pull-down menu) 1601 allows selection of the version information. Alternatively, in the setting screen 1600, the machine model data may also be selectable.

The version information displayed and being selectable by the setting section 1601 is the detected second model information, and is the version information corresponding to the selected machine model data. When the version information of the target model to be activated is input and thereafter a starting button 1602 of the setting screen 1600 is selected, the program proceeds to 1203, in which the model setting section 1003 decides the target model information to be activated. The executing section 1004 activates the program of the image forming apparatus corresponding to the second model information having been set, namely, starts the emulator 403.

When the emulator 403 is activated, the emulation device 400 according to the present embodiment detects the image forming apparatus connected to the network, and obtains the model information (first model information) of the detected image forming apparatus. When the model information storing section 1002 has stored therein the model information (second model information) corresponding to the obtained first model information, the second model information corresponding to the obtained first model information is preferentially set as the target model information to be activated. Accordingly, the emulation device 400 saves trouble in specifying the target model when the emulator 403 is activated. Therefore, for example, even when many models are developed and there are many targets from which selection is made, the emulation device 400 saves trouble in performing the setting operation and reduces the possibility to make an erroneous selection.

When a plurality of pieces of second model information are detected, the following operation may be performed in 1205. For example, a model having a high priority may be placed at the top of the list in the selection area 1501 based on a predetermined rule, or a cursor may be automatically placed on a model having a high priority. The predetermined rule for deciding the priority is, for example, giving priority to a latest model (for example, a model that is developed recently), a higher model, or a model previously activated by the emulator 403. Further, in step, a screen of FIG. 14 may be displayed to allow selection of the machine model data and the version information.

The first model information obtained in the above embodiment includes detailed information such as the machine model data, the firmware version, and the software version as shown in FIG. 7. Alternatively, only the machine model data may be simply obtained, and the second information set at the start of the emulator 403 may include only the machine model data.

In the above embodiment, the emulation device 400 prepared by installing the emulator on the client PC is used. However, the present embodiment is not limited thereto. For example, the simulation system may be configured to include a separate server in which the emulator is installed and which is connected to the client PC via a network, so that the client PC uses the web browsing software function to execute the emulator.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all the components disclosed in the embodiment. Further, components in different embodiments may be appropriately combined.

What is claimed is:

1. An emulation device comprising:
a storing section that stores model information of an apparatus that can be emulated and an emulator corresponding to the model information;
an obtaining section that obtains the model information of the apparatus;
a detection section that detects, from the model information in the storing section, model information corresponding to the model information of the apparatus obtained by the obtaining section; and
an executing section that activates an emulator of the apparatus corresponding to the detected model information.

2. The emulation device according to claim 1, further comprising:
a communication section that communicates with an apparatus on a network when the obtaining section obtains the model information,
wherein the obtaining section obtains the model information of the apparatus via the communication section.

3. The emulation device according to claim 2, further comprising:
a displaying section that displays a selection screen allowing a user to select model information of an apparatus to be emulated from among the model information in the storing section when the obtaining section fails to obtain the model information of the apparatus,
wherein the executing section activates an emulator of an apparatus corresponding to the model information selected on the displaying section.

4. The emulation device according to claim 3, wherein the displaying section displays a message that the apparatus on the network is not detected, when the obtaining section fails to obtain the model information of the apparatus.

5. The emulation device according to claim 1, further comprising:
a displaying section that, when the model information corresponding to the obtained model information of the apparatus is not detected from the model information in the storing section, displays a message that the model information corresponding to the model information of the apparatus is not detected.

6. The emulation device according to claim 5, wherein when the model information corresponding to the obtained model information of the apparatus is not detected from the model information in the storing section, the displaying section displays a setting screen allowing a user to set model information different from the model information of the apparatus from the model information in the storing section, and
wherein the executing section activates an emulator of the apparatus corresponding to the set model information.

7. The emulation device according to claim 1, further comprising:
a displaying section that, when a plurality of pieces of model information corresponding to the model information of the apparatus are detected, displays a screen allowing a user to select any one of the detected model information,
wherein the executing section activates an emulator of the apparatus corresponding to the model information selected on the displaying section.

8. The emulation device according to claim 1, wherein the model information of the apparatus and the detected model information include machine model data and version information of a program,
the emulation device further comprising:
a displaying section that displays a first selection screen allowing a user to select the machine model data of the detected model information, when a plurality of pieces of model information corresponding to the model information of the apparatus are detected from the model information in the storing section;
a determination section that determines whether one piece of version information corresponding to the machine model data selected on the first selection screen is detected or a plurality of pieces of version information corresponding to the type information selected on the first selection screen are detected; and
a controlling section that, when one piece of version information is detected, sets model information corresponding to the detected version information as model information of an apparatus to be emulated and, when a plurality of pieces of version information are detected, causes the displaying section to display a second selection screen allowing the user to select version information of the apparatus to be emulated from the plurality of pieces of version information, the controlling section setting, as the model information of the apparatus to be emulated, model information corresponding to the machine model data and the version information selected on the second selection screen,
wherein the executing section activates an emulator of the apparatus corresponding to the set model information.

9. An activation method of an emulator on an emulation apparatus having a storing section that stores model information of an apparatus that can be emulated and an emulator corresponding to the model information, the activating method comprising:
obtaining model information of an apparatus via an interface;
detecting, from the model information in the storing section, model information corresponding to the obtained model information of the apparatus; and
activating an emulator of the apparatus corresponding to the detected model information.

10. The activation method according to claim 9, further comprising:
displaying, on a displaying section, a selection screen allowing a user to select model information of an apparatus to be emulated from among the model information in the storing section when the model information of the apparatus fails to be obtained;
setting the selected model information as model information of an apparatus to be emulated; and
activating an emulator of the apparatus corresponding to the set model information.

11. The activation method according to claim 10, wherein a message that the apparatus is not detected is displayed, when the model information of the apparatus fails to be obtained.

12. The activation method according to claim 9, further comprising:
displaying a message that the model information corresponding to the model information of the apparatus is not detected when the model information corresponding to the obtained model information of the apparatus is not detected from the model information in the storing section.

13. The activation method according to claim 12, wherein when the model information corresponding to the model information of the apparatus is not detected from the model information in the storing section, a setting screen is displayed to allow a user to input model information different from the model information of the apparatus from the model information in the storing section,
the input model information is set as model information of an apparatus to be emulated, and
an emulator of the apparatus corresponding to the set model information is activated.

14. The activation method according to claim 9, further comprising:
when a plurality of pieces of model information corresponding to the model information of the apparatus are detected, displaying a screen allowing a user to select any one of the detected model information on the displaying section; and
activating an emulator of the apparatus corresponding to the selected model information.

15. A storage medium storing a computer-executable program for executing an activation method of an emulator on an emulation apparatus having a storing section that stores model information of an apparatus that can be emulated and an emulator corresponding to the model information, the method comprising:
obtaining model information of an apparatus via an interface;
detecting, from the model information in the storing section, model information corresponding to the obtained model information of the apparatus; and
activating an emulator of the apparatus corresponding to the detected model information.

16. The storage medium according to claim 15, the activation method further comprising:
displaying, on a displaying section, a selection screen allowing a user to select model information of an apparatus to be emulated from among the model information in the storing section when the model information of the apparatus fails to be obtained;
setting the selected model information as model information of an apparatus to be emulated; and
activating an emulator of the apparatus corresponding to the set model information.

17. The storage medium according to claim 16, wherein a message that the apparatus is not detected is displayed, when the model information of the apparatus fails to be obtained.

18. The storage medium according to claim 15, the activation method further comprising:
displaying a message that the model information corresponding to the model information of the apparatus is not detected when the model information corresponding to the obtained model information of the apparatus is not detected from the model information in the storing section.

19. The storage medium according to claim 18, wherein when the model information corresponding to the model information of the apparatus is not detected from the model information in the storing section, a setting screen is displayed to allow a user to input model information different from the model information of the apparatus from the model information in the storing section,
the input model information is set as model information of an apparatus to be emulated, and
an emulator of the apparatus corresponding to the set model information is activated.

20. The storage medium according to claim 15, the activation method further comprising:
displaying a screen allowing a user to select any one of the detected model information on the displaying section when a plurality of pieces of model information corresponding to the model information of the apparatus are detected; and
activating an emulator of the apparatus corresponding to the selected model information.
